(19) United States
(12) Patent Application Publication
(10) Pub. No.: US 2024/0286360 A1
(43) Pub. Date: Aug. 29, 2024

(54) Three-Dimensional Shaping Apparatus

(71) Applicant: SEIKO EPSON CORPORATION, Tokyo (JP)

(72) Inventor: Masayuki GOZU, Ina (JP)

(21) Appl. No.: 18/585,469

(22) Filed: Feb. 23, 2024

(30) Foreign Application Priority Data
Feb. 24, 2023 (JP) 2023-026862

(51) Int. Cl. B29C 64/393; B29C 64/209; B29C 64/232; B29C 64/236; B29C 64/245; B29C 64/295; B33Y 30/00; B33Y 50/02

(52) U.S. Cl. CPC B29C 64/393; B29C 64/232; B29C 64/236; B29C 64/295; B33Y 30/00; B33Y 50/02; B29C 64/209; B29C 64/245

(57) ABSTRACT

A three-dimensional shaping apparatus includes a shaping unit including a nozzle that ejects a shaping material from a nozzle opening formed at a distal end, a stage having a deposition surface on which the shaping material is deposited, a first detecting unit including a contactor and configured to come into contact with the deposition surface to thereby measure parallelism of the deposition surface, a first moving unit configured to change relative positions of the nozzle and the stage, a second moving unit configured to change a position of the first detecting unit, and a control unit. The control unit controls the second moving unit to locate the first detecting unit on an inner side of a shaping region between the nozzle and the deposition surface when the parallelism is measured and locate the first detecting unit on an outside of the shaping region when a three-dimensional shaped object is shaped.

The present application is based on, and claims priority from JP Application Serial Number 2023-026862, filed Feb. 24, 2023, the disclosure of which is hereby incorporated by reference herein in its entirety.

### BACKGROUND

### 1. Technical Field

The present disclosure relates to a three-dimensional shaping apparatus.

### 2. Related Art

For example, JP-A-2017-217792 discloses a three-dimensional shaping apparatus including a detecting unit integrally supported by a placement table in order to detect a distance L3 to a distal end portion of a nozzle and means for acquiring a distance L5 between a placement surface of the placement table and the detecting unit. In the apparatus, a distance L from the placement surface to the distal end portion of the nozzle is detected based on a distance (L3-L5) obtained by subtracting the distance L3 from the distance L5. The apparatus includes a noncontact-type range finding sensor as the detecting unit and the distance acquiring means.

In order to accurately perform shaping, parallelism between a plane on which a nozzle moves and the surface of a stage is important. Therefore, it is desired to accurately measure parallelism of the stage, for example, when the stage has been attached or detached. The inventor conceived to use a contact-type detecting unit in order to accurately perform measurement at low cost. However, the inventor found a problem in that, when the contact-type detecting unit is used, the contact-type detecting unit is likely to hinder shaping depending on disposition of the contact-type detecting unit.

### SUMMARY

According to a first aspect of the present disclosure, a three-dimensional shaping apparatus is provided. The three-dimensional shaping apparatus includes: a shaping unit including a nozzle that ejects a shaping material from a nozzle opening formed at a distal end; a stage having a deposition surface on which the shaping material is deposited; a first detecting unit including a contactor and configured to come into contact with the deposition surface to thereby measure parallelism of the deposition surface; a first moving unit configured to change relative positions of the nozzle and the stage; a second moving unit configured to change a position of the first detecting unit; and a control unit. The control unit controls the second moving unit to locate the first detecting unit on an inner side of a shaping region between the nozzle and the deposition surface when the parallelism is measured and locate the first detecting unit on an outside of the shaping region when a three-dimensional shaped object is shaped.

### BRIEF DESCRIPTION OF THE DRAWINGS

FIG. 1 is a perspective view schematically showing a three-dimensional shaping apparatus in a first embodiment.

FIG. 2 is a schematic sectional view schematically showing the three-dimensional shaping apparatus.

FIG. 3 is a schematic sectional view schematically showing the three-dimensional shaping apparatus.

FIG. 4 is a perspective view showing a schematic configuration of a screw.

FIG. 5 is a schematic plan view of a barrel.

FIG. 6 is a schematic diagram showing internal configurations of a first detecting unit and a second detecting unit.

FIG. 7 is a perspective view showing a configuration of a stage.

FIG. 8 is a flowchart of three-dimensional shaping processing.

FIG. 9 is a flowchart of nozzle distance measurement processing.

FIG. 10 is an explanatory diagram of the nozzle distance measurement processing.

FIG. 11 is a perspective view showing a schematic configuration of the first detecting unit in a second embodiment.

FIG. 12 is a schematic sectional view schematically showing a three-dimensional shaping apparatus in a third embodiment.

FIG. 13 is a diagram showing an example of disposition of the first detecting unit with respect to a heating unit.

### DESCRIPTION OF EMBODIMENTS

### A. First Embodiment

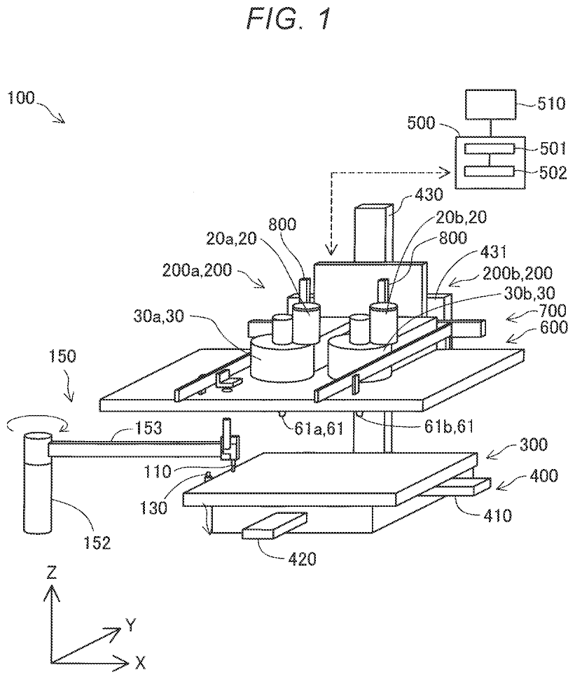

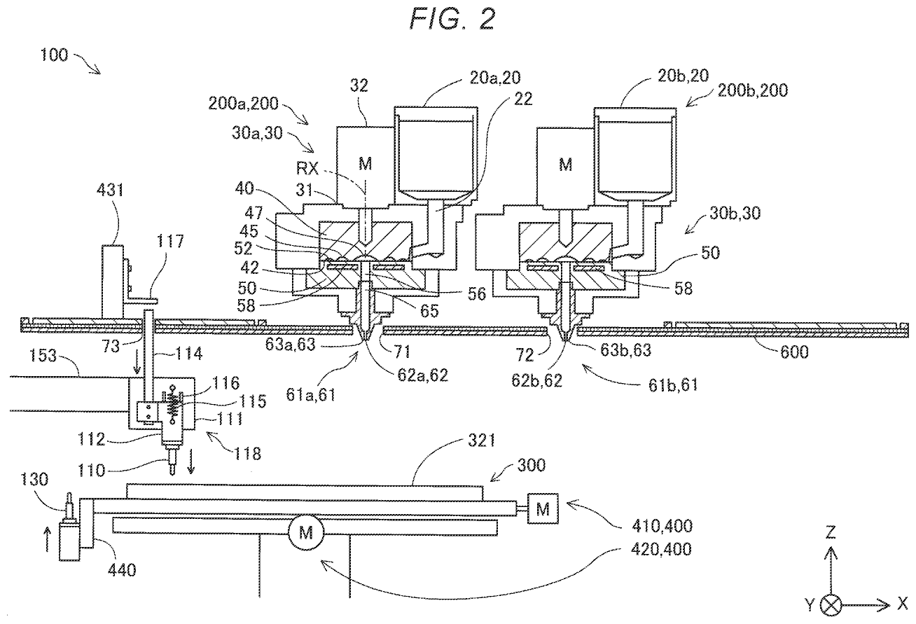

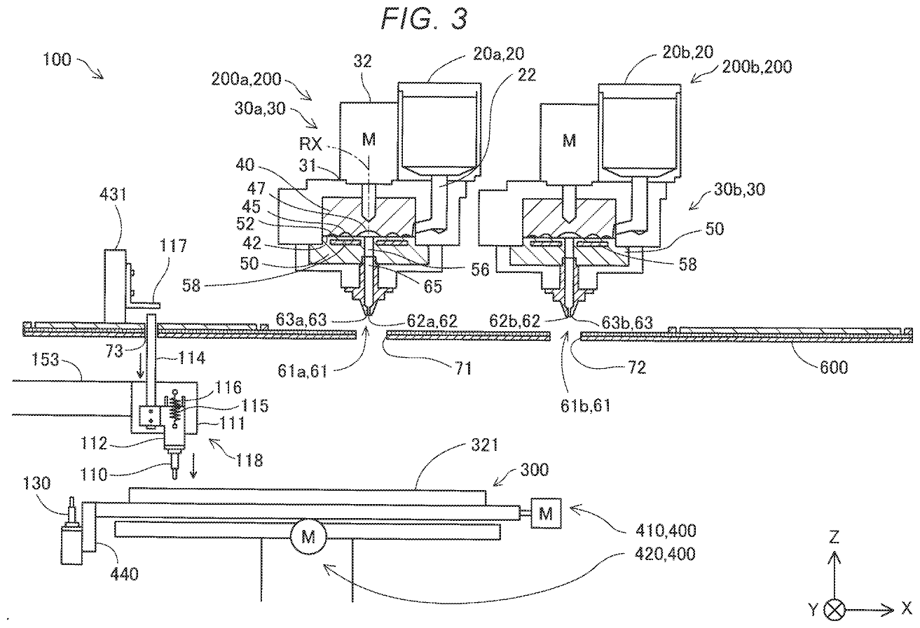

FIG. 1 is a perspective view schematically showing a three-dimensional shaping apparatus 100 in a first embodiment. FIGS. 2 and 3 are schematic sectional views schematically showing the three-dimensional shaping apparatus 100. In FIGS. 1 to 3, arrows extending in X, Y, and Z directions orthogonal to one another are shown. The X, Y, and Z directions are directions extending along an X axis, a Y axis, and a Z axis, which are three spatial axes, orthogonal to one another and respectively include both of directions on one sides extending along the X axis, the Y axis, and the Z axis and opposite directions of the directions. The X axis and the Y axis are axes extending along the horizontal plane. The Z axis is an axis extending along the vertical line. A −Z direction is the vertically downward direction. A +Z direction is the opposite direction of the vertically downward direction. The −Z direction is referred to as “downward” as well. The +Z direction is referred to as “upward” as well. In the other figures, arrows extending in the X, Y, and Z directions are shown as appropriate. The X, Y, and Z directions in FIGS. 1 to 3 and the X, Y, and z directions in the other figures represent the same directions. The Z direction corresponds to the “first direction”.

The three-dimensional shaping apparatus 100 includes shaping units 200, a stage 300, a first moving unit 400, a control unit 500, a supporting unit 700 including a heating unit 600, and nozzle moving units 800.

The control unit 500 is a control device that controls an operation of the entire three-dimensional shaping apparatus 100. The control unit 500 is configured by a computer including one or a plurality of processors 501, a storage unit 502, and an input and output interface through which signals are input from and output to the outside. A display device 510 is connected to the control unit 500. The processors 501 execute a program stored in the storage unit 502, whereby the control unit 500 exerts a function of executing three-dimensional shaping processing explained below. Note that, instead of being configured by the computer, the control unit 500 may be implemented by a configuration in which a plurality of circuits for implementing at least a part of functions are combined.

The shaping units 200 eject, under the control of the control unit 500, a shaping material obtained by plasticizing a solid state material to be paste-like onto the stage 300 for shaping, which is to be a base of a three-dimensional shaped object. The shaping units 200 include material supply units 20, which are supply sources of a material before being converted into the shaping material, plasticizing units 30 that plasticize the material to generate the shaping material, and nozzles 61 that eject the generated shaping material from nozzle openings 62 formed at distal end portions 63. The shaping units 200 are referred to as heads as well.

The three-dimensional shaping apparatus 100 in this embodiment includes a first shaping unit 200a and a second shaping unit 200b as the shaping units 200. The first shaping unit 200a includes a first material supply unit 20a as the material supply unit 20, includes a first plasticizing unit 30a as the plasticizing unit 30, and includes a first nozzle 61a as the nozzle 61. The second shaping unit 200b includes a second material supply unit 20b as the material supply unit 20, includes a second plasticizing unit 30b as the plasticizing unit 30, and includes a second nozzle 61b as the nozzle 61. The first shaping unit 200a and the second shaping unit 200b are disposed side by side in the X direction such that a position in the Y direction of the first nozzle 61a and a position in the Y direction of the second nozzle 61b coincide. In this embodiment, the second shaping unit 200b is disposed in a position in a −X direction corresponding to a position in a +X direction of the first shaping unit 200a. Since a configuration of the first shaping unit 200a and a configuration of the second shaping unit 200b are the same, in the following explanation, the first shaping unit 200a and the second shaping unit 200b are sometimes simply referred to as shaping units 200 when not being distinguished in particular. When components of the first shaping unit 200a and the second shaping unit 200b are distinguished, a sign “a” is added to the components of the first shaping unit 200a and a sign “b” is attached to the components of the second shaping unit 200b.

A material in a pellet state, a powder state, or the like is stored in the material supply units 20. In this embodiment, ABS resin formed to be pellet-like is used as the material. The material supply units 20 in this embodiment are configured by hoppers. As shown in FIG. 2, supply paths 22 connecting the material supply units 20 and the plasticizing units 30 are provided below the material supply units 20. The material supply units 20 supply the material to the plasticizing units 30 via the supply paths 22.

As shown in FIG. 2, the plasticizing units 30 include screw cases 31, driving motors 32, screws 40, and barrels 50. The plasticizing units 30 plasticize at least a part of the material supplied from the material supply units 20, generate a paste-like shaping material having fluidity, and supply the shaping material to the nozzles 61. “Plasticization” is a concept including melting and means changing a solid into a state having fluidity. Specifically, in the case of a material in which glass transition occurs, the plasticization means raising the temperature of the material to a glass transition point or higher. In the case of a material in which glass transition does not occur, the plasticization means raising the temperature of the material to a melting point or higher.

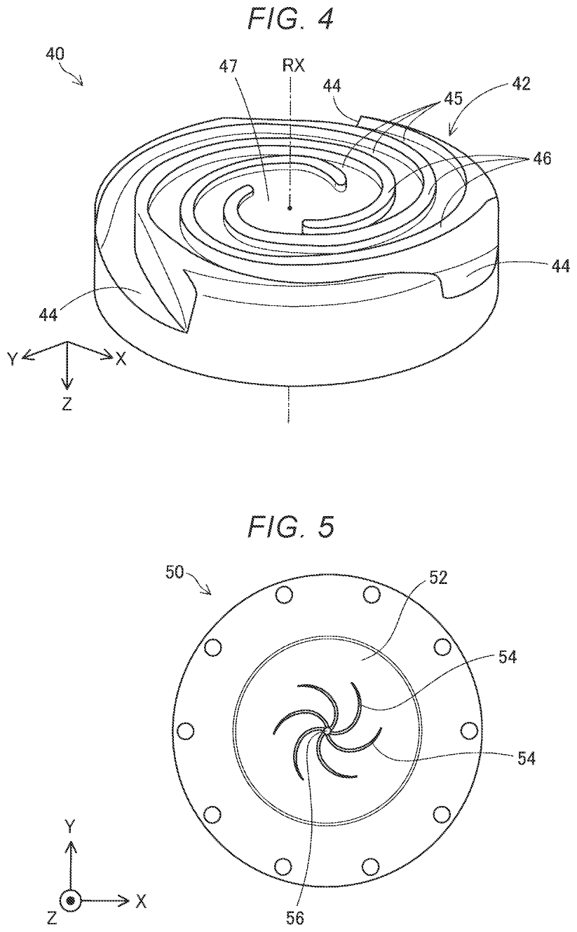

FIG. 4 is a perspective view showing a schematic configuration on a screw lower surface 42 side of the screw 40. FIG. 5 is a schematic plan view showing a barrel upper surface 52 side of the barrel 50. The screw 40 has a substantially columnar shape, the length of which in the axial direction extending along a center axis RX of the screw 40, is smaller than the length thereof in a direction orthogonal to the axial direction. The screw 40 is disposed such that the center axis RX serving as a rotation center of the screw 40 is parallel to the Z direction. The screw 40 is referred to as flat screw, rotor, and scroll as well.

As shown in FIG. 2, the screws 40 are housed in the screw cases 31. The upper surface sides of the screws 40 are coupled to the driving motors 32. The screws 40 rotate in the screw cases 31 with a rotation driving force generated by the driving motors 32. The driving motors 32 are driven under the control of the control unit 500. Note that the screws 40 may be driven by the driving motors 32 via speed reducers.

As shown in FIG. 4, spiral groove sections 45 are formed on the screw lower surface 42. The supply paths 22 of the material supply units 20 explained above communicate with the groove sections 45 from a side surface of the screw 40. The groove sections 45 continue to a material introduction port 44 formed on the side surface of the screw 40. The material introduction port 44 is a portion that receives the material supplied via the supply paths 22 of the material supply units 20. As shown in FIG. 4, in this embodiment, three groove sections 45 are formed by being separated by convex ridge portions 46. Note that the number of groove sections 45 is not limited to three and may be one or may be two or more. The groove sections 45 are not limited to the spiral shape and may be a helical shape or an involute curved line shape or may be a shape extending to draw an arc from a center 47 toward the outer circumference.

As shown in FIG. 2, the barrels 50 are disposed below the screws 40. The barrel upper surfaces 52 face the screw lower surfaces 42. Spaces are formed between the groove sections 45 of the screw lower surfaces 42 and the barrel upper surfaces 52. In the barrels 50, communication holes 56 communicating with nozzle flow paths 65 of the nozzles 61 explained below are provided on the center axes RX of the screws 40. In the barrels 50, plasticizing heaters 58 are incorporated in positions facing the groove sections 45 of the screw 40. The temperature of the plasticizing heaters 58 is controlled by the control unit 500.

As shown in FIG. 5, a plurality of guide grooves 54 are formed around the communication hole 56 on the barrel upper surface 52. One ends of the respective guide grooves 54 are connected to the communication hole 56. The guide grooves 54 spirally extend from the communication hole 56 toward the outer circumference of the barrel upper surface 52. The respective guide grooves 54 have a function of guiding a shaping material to the communication hole 56. Note that the one ends of the guide grooves 54 may not be connected to the communication hole 56. The guide grooves 54 may not be formed in the barrel 50.

The material supplied into the groove section 45 of the screw 40 flows along the groove section 45 according to the rotation of the screw 40 while being melted in the groove section 45 and is guided to the center 47 of the screw 40 as a shaping material. The paste-like shaping material, which has exhibited fluidity, flowing into the center 47 is supplied to the nozzle 61 via the communication hole 56. Note that not all kinds of substances forming the shaping material have to be melted. At least a part of the kinds of substances among the substances forming the shaping material are melted, whereby the shaping material only has to be converted into, as a whole, a state having fluidity.

As shown in FIG. 2, the nozzles 61 include the nozzle flow paths 65 and the distal end portions 63 where the nozzle openings 62 are provided. The nozzle flow paths 65 are shaping material flow paths formed in the nozzles 61 and are connected to the communication holes 56 of the barrels 50 explained above. The distal end portions 63 configure distal end portions of the nozzles 61 projecting in the −Z direction toward the stage 300. The nozzle openings 62 are portions where flow path cross sections of the nozzle flow paths 65 are reduced, the portions being provided at the end portions on sides communicating with the atmosphere of the nozzle flow paths 65. A first nozzle opening 62a is formed at a first distal end portion 63a of the first nozzle 61a. A second nozzle opening 62b is formed at a second distal end portion 63b of the second nozzle 61b. The shaping material generated by the plasticizing units 30 is supplied to the nozzles 61 via the communication holes 56 and ejected from the nozzle openings 62 via the nozzle flow paths 65.

The stage 300 is disposed in a position facing the nozzle openings 62. The three-dimensional shaping apparatus 100 ejects the shaping material from the nozzle openings 62 toward a deposition surface 321 of the stage 300 and stacks a layer of the shaping material on the deposition surface 321 to shape a three-dimensional shaped object. Details of the stage 300 are explained below.

The first moving unit 400 changes relative positions of the nozzles 61 and the stage 300. In this embodiment, the first moving unit 400 moves the shaping units 200 in the Z direction, which is a stacking direction, and moves the stage 300 in a direction crossing the stacking direction to thereby change the relative positions of the nozzles 61 and the stage 300. More specifically, the first moving unit 400 in this embodiment moves the shaping units 200 in the Z direction to thereby change the relative positions of the nozzles 61 and the stage 300 in the Z direction and moves the stage 300 in the X direction and the Y direction orthogonal to the Z direction to thereby change relative positions of the nozzles 61 and the stage 300 in the X direction and the Y direction. As shown in FIG. 1, the first moving unit 400 is configured by a first driving unit 410 that moves the stage 300 in the X direction, a second driving unit 420 that moves the stage 300 and the first driving unit 410 in the Y direction, and a third driving unit 430 that moves the shaping units 200 in the Z direction perpendicular to the deposition surface 321 of the stage 300. More specifically, the third driving unit 430 moves a movable unit 431, to which the first shaping unit 200a and the second shaping unit 200b are fixed, in the Z direction to thereby move the first shaping unit 200a and the second shaping unit 200b in the Z direction. Note that, in FIGS. 2 and 3, the third driving unit 430 and the movable unit 431 are omitted. The first driving unit 410, the second driving unit 420, and the third driving unit 430 are driven under the control of the control unit 500. The first driving unit 410, the second driving unit 420, and the third driving unit 430 are, for example, electric actuators.

As shown in FIG. 1, the supporting unit 700 is further fixed to the movable unit 431. The supporting unit 700 is considered to be a part of the movable unit 431. The supporting unit 700 supports the heating unit 600 to thereby dispose the heating unit 600 in a position facing the stage 300. Therefore, the third driving unit 430 in this embodiment moves the supporting unit 700 in the Z direction together with the shaping units 200 in a state in which a positional relation between the shaping units 200 and the supporting unit 700 is maintained. That is, the supporting unit 700 is considered to be configured such that a position of the supporting unit 700 relative to the stage 300 changes together with positions of the nozzles 61 relative to the stage 300. Similarly, the heating unit 600 supported by the supporting unit 700 is considered to be configured such that a position of the heating unit 600 relative to the stage 300 changes together with the positions of the nozzles 61 relative to the stage 300.

The heating unit 600 heats the shaping material deposited on the deposition surface 321 of the stage 300. The shape of the heating unit 600 is a plate shape and is a rectangular shape when viewed from the Z direction perpendicular to the deposition surface 321. The heating unit 600 is fixed to the movable unit 431 driven by the third driving unit 430. The heating unit 600 is configured such that a position relative to the stage 300 changes together with positions of the first shaping unit 200a and the second shaping unit 200b relative to the stage 300. In this embodiment, the control unit 500 causes the third driving unit 430 to move the heating unit 600 in the Z direction together with the shaping units 200. In this embodiment, the control unit 500 controls the first driving unit 410 and the second driving unit 420 to thereby change relative positions of the heating unit 600 and the stage 300 in a range in which at least a part of the heating unit 600 and at least a part of the stage 300 overlap when viewed from the Z direction. In the heating unit 600, a first opening 71, a second opening 72, and a third opening 73 piercing through the heating unit 600 in the Z direction are provided. The first opening 71 is provided in a position corresponding to the first nozzle 61a. The second opening 72 is provided in a position corresponding to the second nozzle 61b. The third opening 73 is provided between the outer edge of the heating unit 600 and the first opening 71.

The nozzle moving units 800 shown in FIG. 1 change relative positions of the nozzles 61 and the heating unit 600. In the three-dimensional shaping apparatus 100, two nozzle moving units 800 are provided to correspond to the first shaping unit 200a and the second shaping unit 200b. The nozzle moving units 800 are fixed to the movable unit 431 and moved in the Z direction by the third driving unit 430 together with the heating unit 600. The nozzle moving units 800 are configured as, for example, electric actuators and are driven under the control of the control unit 500. The nozzle moving units 800 move the shaping units 200 in the Z direction to thereby change relative positions of the nozzles 61 and the heating unit 600. In this embodiment, one nozzle moving unit 800 moves the first shaping unit 200a in the Z direction and the other nozzle moving unit 800 moves the second shaping unit 200b in the Z direction. The nozzle moving units 800 are respectively individually controlled by the control unit 500. In other embodiments, for example, the nozzle moving units 800 may move only the nozzles 61 in the Z direction rather than moving the entire shaping units 200.

In this embodiment, the first nozzle 61a and the second nozzle 61b are respectively configured to be capable of switching a shaping state and a retracted state with the nozzle moving units 800. The shaping state is shown in FIG. 2 and the retracted state is shown in FIG. 3. The shaping state is a state in which at least a part of the nozzle 61 is disposed in the first opening 71 or the second opening 72 as shown in FIG. 2. The nozzle opening 62 of the nozzle 61 in the shaping state is disposed between the heating unit 600 and the stage 300 in the Z direction. That is, the heating unit 600 is located above the nozzle opening 62 during shaping of a three-dimensional shaped object. The retracted state is a state in which the nozzle 61 is disposed above the first opening 71 or the second opening 72 to be disposed outside the first opening 71 or the second opening 72 as shown in FIG. 3. The nozzle moving unit 800 moves the shaping unit 200 in the +Z direction when switching the nozzle 61 from the shaping state to the retracted state and moves the shaping unit 200 in the −Z direction when switching the nozzle 61 from the retracted state to the shaping state. By controlling the nozzle moving unit 800 to bring the nozzle 61 not used in the three-dimensional shaping processing into the retracted state, the control unit 500 can prevent the nozzle 61 from coming into contact with a shaped object. Note that, in the retracted state, for example, the nozzle 61 may be cleaned by a not-shown cleaning mechanism.

As shown in FIGS. 1 and 2, the three-dimensional shaping apparatus 100 in this embodiment includes a first detecting unit 110, a second detecting unit 130, and a second moving unit 150.

The first detecting unit 110 and the second detecting unit 130 are detecting units of a contact type that come into contact with a target object to output detection signals to the control unit 500. The first detecting unit 110 comes into contact with the deposition surface 321 of the stage 300 to be used to measure parallelism of the deposition surface 321. The parallelism means a parallel degree with respect to a reference plane. The reference plane is a plane on which the nozzle 61 moves and is a horizontal plane in this embodiment.

The second moving unit 150 changes the position of the first detecting unit 110. When the parallelism of the deposition surface 321 is measured, the control unit 500 controls the second moving unit 150 to move the first detecting unit 110 to the inner side of a shaping region between the nozzle 61 and the deposition surface 321. The shaping region is a space between the nozzle 61 in the shaping state and the deposition surface 321 and is a space in which a three-dimensional shaped object can be shaped. When the three-dimensional shaped object is shaped, the control unit 500 controls the second moving unit 150 to locate the first detecting unit 110 on the outside of the shaping region.

In this embodiment, the second moving unit 150 includes a column 152 extending in the +Z direction and an arm 153. The arm 153 extends perpendicularly from the column 152 and is rotatably attached to the column 152. The first detecting unit 110 is provided at the distal end of the arm 153. A motor for rotating the arm 153 is built in the column 152. The rotation of the arm 153 is controlled by the control unit 500. The first detecting unit 110 rotationally moves with respect to the column 152 to move into the shaping region. Note that the second moving unit 150 is not limited to be configured to rotationally move the first detecting unit 110 and, for example, may move the first detecting unit 110 into the shaping region with a stretching arm or a translating arm.

As shown in FIG. 2, the first detecting unit 110 is provided in a detecting unit supporting mechanism 118. The detecting unit supporting mechanism 118 includes a base unit 111, a supporting member 112, a contact unit 114, a spring 115, and a guide rail 116.

The base unit 111 is fixed to the distal end of the arm 153. The guide rail 116 is provided in the Z direction in the base unit 111. The supporting member 112 is attached to the guide rail 116 to be slidable in the Z direction. The first detecting unit 110 is provided below the supporting member 112. The contact unit 114 having a bar shape is provided above the supporting member 112. The supporting member 112 and the base unit 111 are coupled by the spring 115 that stretches in the Z direction. The upper end portion of the contact unit 114 can be inserted through the third opening 73 provided in the heating unit 600. A pushing plate 117 for pushing the contact unit 114 downward is fixed to the movable unit 431 in which the heating unit 600 is provided. The pushing plate 117 configures a part of the movable unit 431.

The control unit 500 controls the second moving unit 150 to move the first detecting unit 110 to the shaping region in a state in which the heating unit 600 is located above the contact unit 114. The control unit 500 controls the first moving unit 400 to lower the heating unit 600, insert the contact unit 114 of the first detecting unit 110 through the third opening 73, and push and move the contact unit 114 in the −Z direction with the pushing plate 117 fixed to the movable unit 431. Then, the first detecting unit 110 moves downward resisting a tensile force of the spring 115. The first detecting unit 110 comes into contact with the deposition surface 321 of the stage 300. When the contact is detected by the first detecting unit 110, the control unit 500 stops the lowering of the heating unit 600 and, thereafter, lifts the heating unit 600. Then, the first detecting unit 110 separates from the deposition surface 321 and rises with the tensile force of the spring 115 and returns to the original position.

The second detecting unit 130 is fixed to the stage 300. In this embodiment, the second detecting unit 130 is fixed to a portion further on the outer side than the deposition surface 321 of the stage 300. When the stage 300 is moved by the first moving unit 400, the second detecting unit 130 moves in association with the movement of the stage 300. The second detecting unit 130 can be moved in the Z direction by a fourth driving unit 440 attached to the stage 300. The fourth driving unit 440 is controlled by the control unit 500. The control unit 500 can measure the distance between the deposition surface 321 of the stage 300 and the distal end portion 63 of the nozzle 61 using the first detecting unit 110 and the second detecting unit 130. Details of a measurement method are explained below.

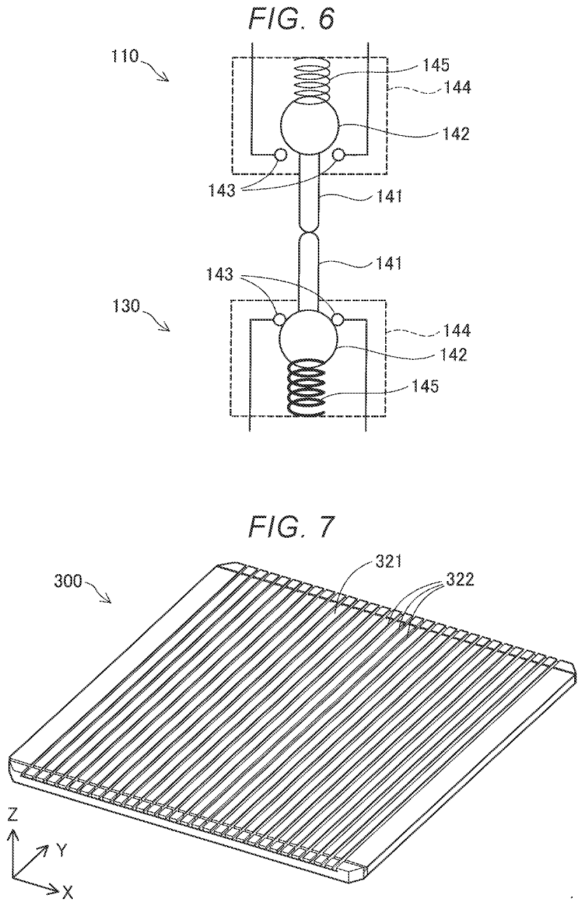

FIG. 6 is a schematic diagram showing internal configurations of the first detecting unit 110 and the second detecting unit 130. In this embodiment, the first detecting unit 110 and the second detecting unit 130 are respectively configured as contact sensors of a B contact type. The first detecting unit 110 and the second detecting unit 130 respectively include contactors 141, conductors 142, pairs of contacts 143, housings 144, and springs 145. The contactors 141 are portions that come into contact with a target object. The contactors 141 have, for example, a bar-like shape. The conductors 142 are fixed to the proximal ends of the contactors 141. The springs 145 are disposed between the conductors 142 and the housings 144. When the contactors 141 are not in contact with the target object, the springs 145 urge the conductors 142 to the contactors 141 sides to bring the conductors 142 into contact with the pairs of contacts 143. In this state, the pairs of contacts 143 are electrically connected via the conductors 142. In contrast, when the contactors 141 come into contact with the target object, since the conductors 142 push in the springs 145 and separate from the pairs of contacts 143, the pairs of contacts 143 are electrically disconnected. The first detecting unit 110 and the second detecting unit 130 watch an electric connection state of the pairs of contacts 143 to detect whether the contactors 141 have come into contact with the target object and, when the contactors 141 have come into contact with the target object, output detection signals to the control unit 500.

In this embodiment, an urging force of the spring 145 in the first detecting unit 110 and an urging force of the spring 145 in the second detecting unit 130 are different. The urging forces can be adjusted by adjusting spring constants of the respective springs 145. Consequently, in this embodiment, the first detecting unit 110 and the second detecting unit 130 are configured such that, when the first detecting unit 110 and the second detecting unit 130 have come into contact, a specific one detecting unit of the first detecting unit 110 and the second detecting unit 130 detects the contact. In this embodiment, the urging force of the spring 145 of the first detecting unit 110 is set smaller than the urging force of the spring 145 of the second detecting unit 130. Therefore, when the first detecting unit 110 and the second detecting unit 130 are brought into contact with each other, since the spring 145 of the first detecting unit 110 is compressed earlier as shown in FIG. 6, a detection signal is output from the first detecting unit 110. Note that, in this embodiment, the first detecting unit 110 and the second detecting unit 130 are the contact sensors of the B contact type. However, the first detecting unit 110 and the second detecting unit 130 can also be configured by contact sensors of an A contact type. In the other embodiments, the urging force of the spring 145 of the first detecting unit 110 may be set larger than the urging force of the spring 145 of the second detecting unit 130.

FIG. 7 is a perspective view showing a configuration of the stage 300. The stage 300 is formed by, for example, aluminum, stainless steel, or glass. A plurality of grooves 322 extending in the Y direction are formed on the deposition surface 321 of the stage 300 to be disposed side by side at a fixed interval in the X direction. An anchor effect is exerted by the grooves 322 and adhesion of the three-dimensional shaped object to the deposition surface 321 is improved. In this embodiment, the stage 300 can be attached to and detached from the first moving unit 400. Other than the stage 300 shown in FIG. 7, a user may attach, to the first moving unit 400, a stage on which the positions of the grooves 322 are different or a stage on which the grooves 322 are not formed.

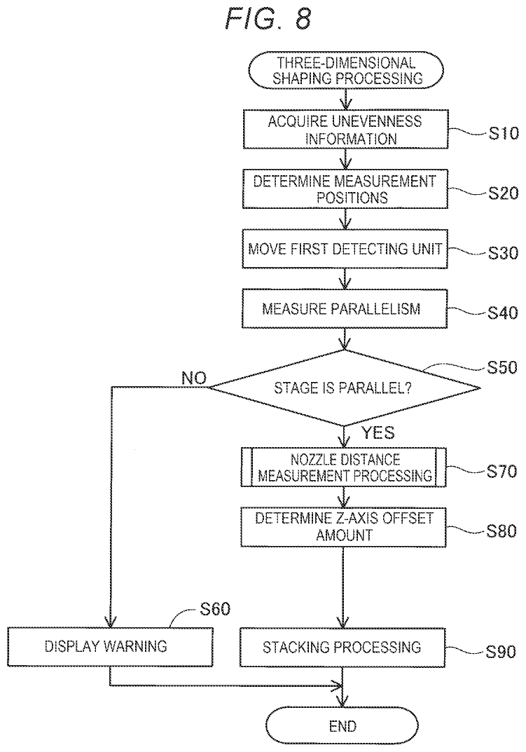

FIG. 8 is a flowchart of the three-dimensional shaping processing executed by the control unit 500. The three-dimensional shaping processing is executed when predetermined shaping start operation is performed on the control unit 500. Note that, it is assumed that, at a start time of the three-dimensional shaping processing, the heating unit 600 is located above the contact unit 114.

When the execution of the three-dimensional shaping processing is started, in step S10, the control unit 500 acquires unevenness information. The unevenness information is information representing unevenness positions of the deposition surface 321 of the stage 300. In this embodiment, the unevenness positions are positions of the grooves 322 shown in FIG. 7. For example, the user inputs, using an input device or the like coupled to the control unit 500, information representing a type of the stage 300 attached to the first moving unit 400. The control unit 500 specifies, from the input information, the stage 300 corresponding to the information and acquires the unevenness information correlated with the stage 300 from the storage unit 502 in the control unit 500 or another device. The unevenness information may be included in shaping data for shaping a three-dimensional shaped object.

In step S20, the control unit 500 determines, based on the unevenness information acquired in step S10, measurement positions for measuring parallelism of the deposition surface 321. In this embodiment, the control unit 500 specifies, as the measurement positions, four different positions where the grooves 322 are not formed on the deposition surface 321. The four different positions are, for example, the positions of the four corners of the deposition surface 321 or the positions of the four corners of a rectangle diagonally having one corner and the center of the deposition surface 321.

In step S30, the control unit 500 controls the second moving unit 150 to move the first detecting unit 110 from the outside to the inside of the shaping region. More specifically, the control unit 500 locates the first detecting unit 110 below the heating unit 600 such that the contact unit 114 is located right below the third opening 73 in the heating unit 600.

In step S40, the control unit 500 measures parallelism of the deposition surface 321. Speifically, the control unit 500 controls the second moving unit 150 to lower the heating unit 600 to thereby lower the first detecting unit 110 with the pushing plate 117 provided in the movable unit 431 and bring the first detecting unit 110 into contact with the deposition surface 321 of the stage 300. The control unit 500 controls the first moving unit 400 to change the position of the stage 300 with respect to the first detecting unit 110 to bring the first detecting unit 110 into contact with the deposition surface 321 in all the measurement positions determined in step S20. Consequently, it is possible to measure the heights of the deposition surface 321 in the measurement positions. The control unit 500 calculates a difference between a maximum value and a minimum value of the measured heights as parallelism. The control unit 500 may display the calculated parallelism on the display device 510. The control unit 500 may display not only the parallelism but also measurement values and the measurement positions on the display device 510.

In step S50, the control unit 500 determines, based on the parallelism measured in step S40, whether the deposition surface 321 of the stage 300 is parallel to the horizontal plane. In this embodiment, if the parallelism is smaller than a predetermined threshold, the control unit 500 determines that the deposition surface 321 is parallel to the horizontal plane. When determining in step S50 that the deposition surface 321 is not parallel to the horizontal plane, in step S60, the control unit 500 displays a warning on the display device 510 coupled to the control unit 500. In this embodiment, for example, the control unit 500 displays a warning “Please attach the stage again”. The threshold described above is determined according to a stacking pitch in shaping the three-dimensional shaped object. In this embodiment, the same value as the stacking pitch is set as the threshold. The threshold is, for example, 0.05 mm to 0.5 mm.

When determining in step S50 that the deposition surface 321 is parallel to the horizontal plane, in step S70, the control unit 500 executes nozzle distance measurement processing. The nozzle distance measurement processing is processing for measuring the distance between the nozzle 61 and the deposition surface 321. Details of the nozzle distance measurement processing are explained below.

In step S80, the control unit 500 determines a Z-axis offset amount based on the distance between the nozzle 61 and the deposition surface 321 measured in step S70. Specifically, the control unit 500 calculates a difference between the distance measured in step S70 and a predetermined reference value and determines the difference as the Z-axis offset amount. The predetermined reference value is, for example, a design value of the distance between the nozzle 61 and the deposition surface 321.

In step S90, the control unit 500 executes stacking processing. In the stacking processing, the control unit 500 stacks the shaping material on the deposition surface 321 using shaping data acquired through a recording medium or a network and shapes the three-dimensional shaped object. The shaping data includes path data representing a path of relative movement of the nozzle 61 with respect to the stage 300 and ejection amount data representing an amount of the shaping material ejected from the nozzle 61. When moving the nozzle 61 in the Z direction, the control unit 500 corrects the position in the Z direction of the nozzle 61 with the Z-axis offset value determined in step S80. Consequently, it is possible to accurately shape the three-dimensional shaped object on the stage 300. Note that, when the three-dimensional shaped object is shaped in step S90, the first detecting unit 110 is retracted to the outside of the shaping region in step S73 of nozzle distance measurement processing explained below.

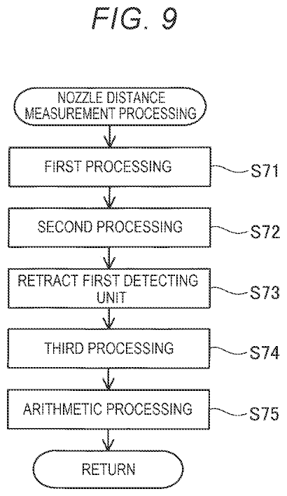

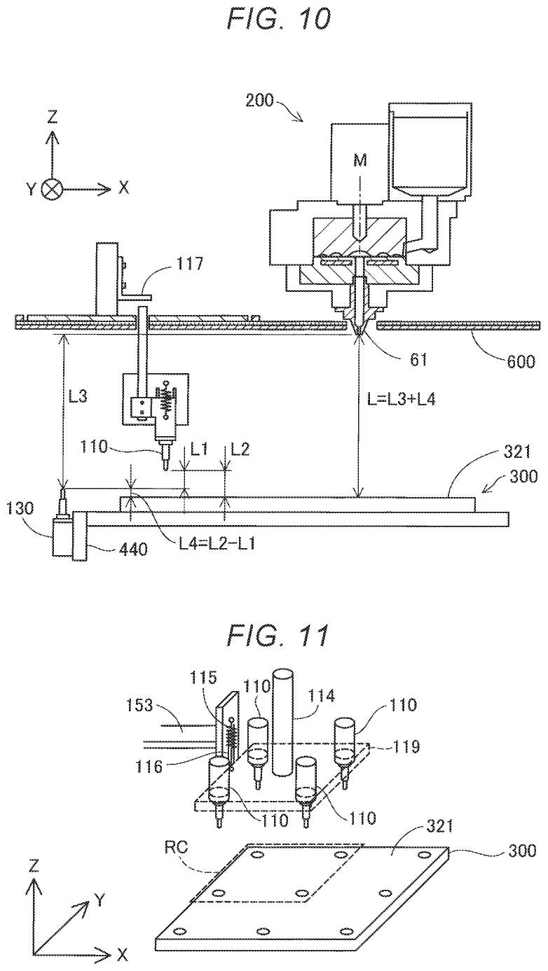

FIG. 9 is a flowchart of the nozzle distance measurement processing executed in step S70 explained above. FIG. 10 is an explanatory diagram of the nozzle distance measurement processing.

In step S71, the control unit 500 executes first processing for bringing the first detecting unit 110 and the second detecting unit 130 into contact. In the first processing, the control unit 500 controls the fourth driving unit 440 to move the distal end in the +Z direction of the second detecting unit 130 further in the +Z direction than the deposition surface 321. The control unit 500 controls the first driving unit 410 and the second driving unit 420 of the first moving unit 400 to match the position in the X direction and the Y direction of the second detecting unit 130 to the position of the first detecting unit 110. The control unit 500 controls the third driving unit 430 of the first moving unit 400 to lower the first detecting unit 110 from a measurement start position until the first detecting unit 110 and the second detecting unit 130 come into contact, that is, until the first detecting unit 110 outputs a detection signal. In the first processing, the control unit 500 calculates a distance L1 from the first detecting unit 110 to the second detecting unit 130 based on a movement amount of the first detecting unit 110 moved by the third driving unit 430.

In step S72, the control unit 500 executes second processing for bringing the first detecting unit 110 and the deposition surface 321 into contact. In the second processing, the control unit 500 controls the first driving unit 410 and the second driving unit 420 of the first moving unit 400 to match the position in the X direction and the Y direction serving as a measurement reference on the deposition surface 321 to the position of the first detecting unit 110. The control unit 500 controls the third driving unit 430 of the first moving unit 400 to lower the first detecting unit 110 from the measurement start position until the first detecting unit 110 outputs a detection signal, that is, until the first detecting unit 110 and the deposition surface 321 come into contact. In the second processing, the control unit 500 calculates a distance L2 from the first detecting unit 110 to the deposition surface 321 based on a movement amount of the first detecting unit 110 moved by the third driving unit 430.

In step S73, the control unit 500 controls the second moving unit 150 to move the first detecting unit 110 and locate the first detecting unit 110 on the outside of the shaping region. More specifically, the control unit 500 locates the first detecting unit 110 further on the outer side than the peripheral edge of the heating unit 600.

In step S74, the control unit 500 executes third processing for bringing the second detecting unit 130 and the nozzle 61 into contact. In the third processing, the control unit 500 controls the first driving unit 410 and the second driving unit 420 of the first moving unit 400 to match the position in the X direction and the Y direction of the second detecting unit 130 to the position of the nozzle 61. The control unit 500 controls the third driving unit 430 of the first moving unit 400 to lower the nozzle 61 from the measurement start position until the second detecting unit 130 outputs a detection signal, that is, until the second detecting unit 130 and the nozzle 61 come into contact. In the third processing, the control unit 500 calculates a distance L3 from the second detecting unit 130 to the nozzle 61 based on a movement amount of the nozzle 61 moved by the third driving unit 430.

In step S75, the control unit 500 executes arithmetic processing for calculating a distance L between the nozzle 61 and the deposition surface 321. In the arithmetic processing, first, the control unit 500 subtracts the distance L1 from the first detecting unit 110 to the second detecting unit 130 from the distance L2 from the first detecting unit 110 to the deposition surface 321 to calculate a distance L4 between the second detecting unit 130 and the deposition surface 321. The control unit 500 adds the distance L4 between the second detecting unit 130 and the deposition surface 321 to the distance L3 from the second detecting unit 130 to the nozzle 61 to calculate the distance L between the nozzle 61 and the deposition surface 321. Note that, in the third processing in step S74, the control unit 500 brings the second detecting unit 130 into contact with each of the first nozzle 61a and the second nozzle 61b to individually calculate a distance between the nozzle 61a and the deposition surface 321 and a distance between the second nozzle 61b and the deposition surface 321. Consequently, it is possible to determine Z-axis offset amounts individually for the first nozzle 61a and the second nozzle 61b.

With the three-dimensional shaping apparatus 100 in the first embodiment explained above, when the parallelism of the deposition surface 321 of the stage 300 is measured, the first detecting unit 110 is located on the inner side of the shaping region between the nozzle 61 and the deposition surface 321 and, when the three-dimensional shaped object is shaped, the first detecting unit 110 is located on the outside of the shaping region. Therefore, it is possible to measure, without hindering the shaping, parallelism of the stage 300 using the first detecting unit 110 of the contact type that is low cost.

The three-dimensional shaping apparatus 100 in the first embodiment includes the plate-like heating unit 600 that is located above the nozzle opening 62 during the shaping and heats the shaping material deposited on the deposition surface 321. When parallelism is measured, the first detecting unit 110 is located below the heating unit 600. When the three-dimensional shaped object is shaped, the first detecting unit 110 is located further on the outer side than the peripheral edge of the heating unit 600. Therefore, it is possible to prevent the first detecting unit 110 and the heating unit 600 from coming into contact.

The three-dimensional shaping apparatus 100 in the first embodiment includes the third driving unit 430 that changes the relative positions of the nozzles 61 and the stage 300 in the Z direction perpendicular to the deposition surface 321 of the stage 300. The first detecting unit 110 includes the contact unit 114 that, in a state in which the first detecting unit 110 is located below the heating unit 600, comes into contact with the movable unit 431 driven by the third driving unit 430. When parallelism is measured, the first detecting unit 110 is moved in the Z direction by the third driving unit 430 in the first moving unit 400. Therefore, it is possible to move the first detecting unit 110 without separately providing a driving unit for moving the first detecting unit 110. As a result, it is possible to simplify the configuration of the three-dimensional shaping apparatus 100.

In the first embodiment, the measurement positions of the deposition surface 321 by the first detecting unit 110 is determined according to the unevenness information representing the unevenness positions of the deposition surface 321 of the stage 300. Therefore, it is possible to accurately measure parallelism of the deposition surface 321.

In the first embodiment, when the first detecting unit 110 and the second detecting unit 130 come into contact with each other, specific one detecting unit of the first detecting unit 110 and the second detecting unit 130 detects the contact. Therefore, a detection source of contact does not vary and the control unit 500 only has to watch presence or absence of a detection signal from one detecting unit. Since the detecting unit serving as the detection source of contact does not vary, distance measurement accuracy is prevented from fluctuating. As a result, it is possible to accurately measure the distance between the first detecting unit 110 and the second detecting unit 130.

In the first embodiment, the distance L1 between the first detecting unit 110 and the second detecting unit 130 is measured by the first processing shown in FIGS. 9 and 10, the distance L2 between the first detecting unit 110 and the deposition surface 321 is measured by the second processing shown in FIGS. 9 and 10, and the distance L3 between the second detecting unit 130 and the nozzle 61 is measured by the third processing unit shown in FIGS. 9 and 10. Therefore, even if the height of the second detecting unit 130 and the height of the deposition surface 321 are different, it is possible to accurately measure the distance L (=L3+L4) between the nozzle 61 and the deposition surface 321 by calculating the distance L4 (=L2−L1) between the second detecting unit 130 and the deposition surface 321.

In the first embodiment, when the three-dimensional shaped object is shaped, since the first detecting unit 110 is retracted to the outside of the shaping region, the first detecting unit 110 is less easily affected by heat of the heating unit 600. Therefore, it is possible to use the first detecting unit 110 that has low heat resistance and is low cost.

### B. Second Embodiment

FIG. 11 is a perspective view showing a schematic configuration of the first detecting unit 110 in a second embodiment. In the first embodiment explained above, one first detecting unit 110 is provided in the three-dimensional shaping apparatus 100. In contrast, in the second embodiment, a plurality of first detecting units 110 are provided in the three-dimensional shaping apparatus 100. The plurality of first detecting units 110 are fixed to one holder 119. The holder 119 corresponds to the supporting member 112 in the first embodiment. The plurality of first detecting units 110 are capable of coming into contact with different positions of the deposition surface 321. The second moving unit 150 can simultaneously move the plurality of first detecting units 110 by moving the holder 119. The contact unit 114 provided in the holder 119 is pushed by the pushing plate 117 in the movable unit 431, whereby the first detecting units 110 move in the Z direction together with the holder 119. Attachment positions in a plane direction of the first detecting units 110 to the holder 119 are preferably optionally adjustable in order to avoid the grooves 322 provided in the stage 300.

According to the second embodiment, different positions of the deposition surface 321 can be simultaneously measured by the plurality of first detecting units 110. Therefore, it is possible to efficiently measure parallelism of the deposition surface 321.

For example, when the plurality of first detecting units 110 are disposed in positions corresponding to the positions of the four corners of a rectangle RC diagonally having one corner and the center of the deposition surface 321 as shown in FIG. 11, it is possible to measure parallelism of the entire deposition surface 321 by performing measurement four times while moving the stage 300. When there is only one first detecting unit 110, it is necessary to perform measurement nine times while moving the stage 300. Therefore, when the plurality of first detecting units 110 are disposed, it is possible to greatly reduce a measurement time. It is possible to detect not only the parallelism but also deformation such as a warp of the stage 300 by performing the measurement of the entire deposition surface 321.

### C. Third Embodiment

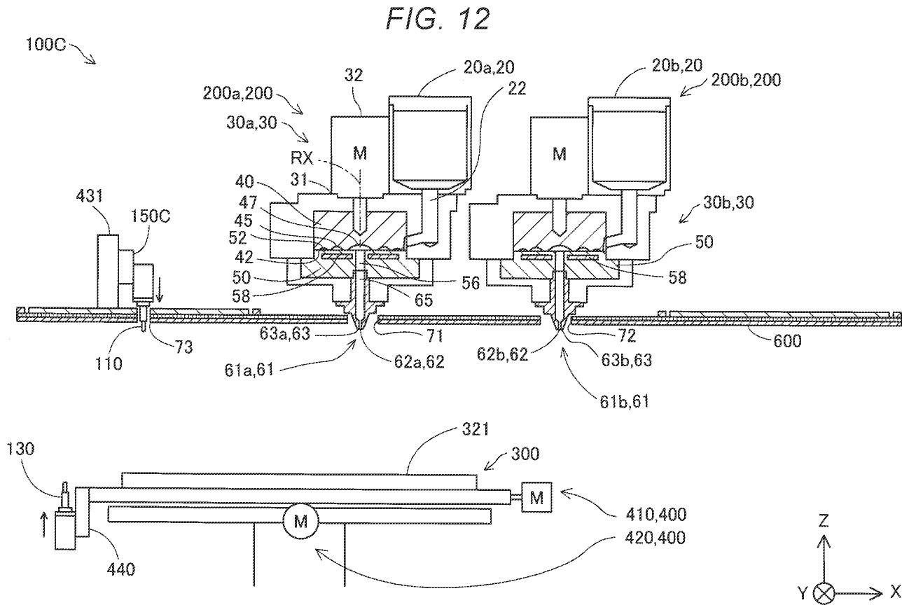

FIG. 12 is a schematic sectional view schematically showing a three-dimensional shaping apparatus 100C in a third embodiment. In the first embodiment explained above, the first detecting unit 110 moves from the outer side than the peripheral edge of the heating unit 600 to below the heating unit 600. In contrast, in the third embodiment, the first detecting unit 110 moves from above the heating unit 600 to below the heating unit 600.

In the third embodiment, the first detecting unit 110 is attached to the movable unit 431. The first detecting unit 110 can be moved in the Z direction by a second moving unit 150C provided in the movable unit 431. The second moving unit 150C is controlled by the control unit 500. The second moving unit 150C is configured by, for example, an electric linear actuator.

When parallelism is measured, the control unit 500 controls the second moving unit 150C to locate the first detecting unit 110 below the heating unit 600. More specifically, the control unit 500 locates the distal end in the −Z direction of the first detecting unit 110 below the heating unit 600 through the third opening 73 provided in the heating unit 600. When a three-dimensional shaped object is shaped, the control unit 500 locates the first detecting unit 110 above the heating unit 600. More specifically, the control unit 500 locates the distal end in the −Z direction of the first detecting unit 110 above the lower surface of the heating unit 600.

According to the second embodiment explained above, as in the first embodiment, it is possible to measure, without hindering the shaping, parallelism of the stage 300 using the first detecting unit 110 of the contact type that is low cost.

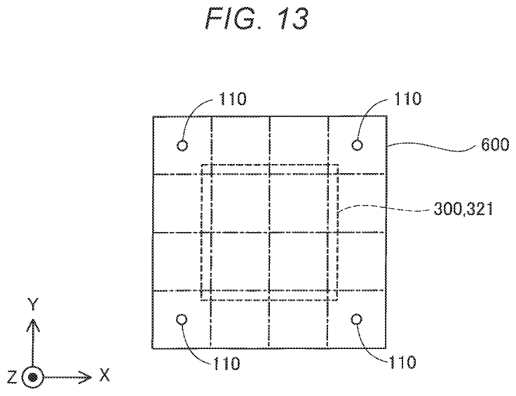

FIG. 13 is a diagram showing an example of disposition of the first detecting unit 110 with respect to the heating unit 600. In the third embodiment, the three-dimensional shaping apparatus 100C may include a plurality of first detecting units 110 in the movable unit 431. For example, as shown in FIG. 13, when the heating unit 600 is equally divided into lateral four regions, that is, four regions in the X direction and longitudinal four regions, that is, four regions in the Y direction when viewed from the Z direction, sixteen regions in total, the first detecting units 110 may be respectively provided in regions corresponding to at least two corners among four corners. In FIG. 13, an example is shown in which the first detecting units 110 are provided in regions corresponding to all of the four corners. Consequently, even in a moving range in which a part of the stage 300 overlaps the heating unit 600 when the stage 300 is moved to the maximum in the X and Y directions, positions of the deposition surface 321 that cannot be measured by one first detecting unit 110 can be measured by the other first detecting units 110. Therefore, even if a moving range of the stage 300 is the range explained above, it is possible to expand a measurable range of the deposition surface 321.

### D. Other Embodiments

(D1) In the embodiments explained above, the processing in step S70 and step S80 of the three-dimensional shaping processing shown in FIG. 8 may be omitted. That is, the nozzle distance measurement processing and the determination of the Z-axis offset amount may be omitted. In this case, the three-dimensional shaping apparatus 100 may not include the second detecting unit 130. Note that, when the nozzle distance measurement processing in step S70 is omitted, the control unit 500 moves the first detecting unit 110 to the outside of the shaping region before executing the stacking processing in step S90.

(D2) In the embodiments explained above, the processing in step S40 to step S60 of the three-dimensional shaping processing shown in FIG. 8, that is, the processing relating to the measurement of the parallelism may be omitted. In this case, the control unit 500 locates the first detecting unit 110 on the inner side of the shaping region when measuring the distance between the nozzle 61 and the deposition surface 321 in step S70 and locates the first detecting unit 110 on the outside of the shaping region when shaping the three-dimensional shaped object in step S90.

(D3) In the embodiments explained above, the processing in step S10 and step S20 shown in FIG. 8 may not be executed. In this case, measurement positions of the deposition surface 321 may be predetermined irrespective of a type of the stage 300.

(D4) In the first embodiment explained above, the first detecting unit 110 is moved in the Z direction by the third driving unit 430 for driving the movable unit 431. In contrast, for example, an electric linear actuator may be provided in the base unit 111 and the control unit 500 may drive the electric linear actuator to thereby move the first detecting unit 110 in the Z direction. In this case, the third opening 73 and the pushing plate 117 provided in the heating unit 600 can be omitted. In addition, in this case, unevenness of the deposition surface 321 may be continuously measured in the plane direction by using a high-precision contact-type digital displacement sensor as the first detecting unit 110.

(D5) In the embodiments explained above, the first moving unit 400 moves the shaping units 200 in the Z direction and moves the stage 300 in the X direction and the Y direction. In contrast, for example, the first moving unit 400 may move the stage 300 in the Z direction and move the shaping units 200 in the X direction and the Y direction. The first moving unit 400 may move the stage 300 in the X direction, the Y direction, and the Z direction without moving the shaping units 200. The first moving unit 400 may move the shaping units 200 in the X direction, the Y direction, and the Z direction without moving the stage 300.

(D6) In the embodiments explained above, the three-dimensional shaping apparatus 100, 100c includes the two shaping units 200. In contrast, the three-dimensional shaping apparatus 100, 100c may include only one shaping unit 200 or may include three or more shaping units 200.

(D7) In the embodiments explained above, the order of the processing in step S71, step S72, and step S74 of the nozzle distance measurement processing shown in FIG. 9 may be changed. In this case, step S73 is executed before step S74.

### E. Other Aspects

The present disclosure is not limited to the embodiments explained above and can be implemented in various configurations in a range not departing from the gist of the present disclosure. For example, the technical features in the embodiments corresponding to technical features in aspects described below can be substituted or combined as appropriate in order to solve a part or all of the problems described above or achieve a part or all of the effects described above. Unless the technical features are explained as essential technical features in this specification, the technical features can be deleted as appropriate.

(1) According to a first aspect of the present disclosure, a three-dimensional shaping apparatus is provided. The three-dimensional shaping apparatus includes: a shaping unit including a nozzle that ejects a shaping material from a nozzle opening formed at a distal end; a stage having a deposition surface on which the shaping material is deposited; a first detecting unit including a contactor and configured to come into contact with the deposition surface to thereby measure parallelism of the deposition surface; a first moving unit configured to change relative positions of the nozzle and the stage; a second moving unit configured to change a position of the first detecting unit; and a control unit. The control unit controls the second moving unit to locate the first detecting unit on an inner side of a shaping region between the nozzle and the deposition surface when the parallelism is measured and locate the first detecting unit on an outside of the shaping region when a three-dimensional shaped object is shaped.

According to such an aspect, it is possible to measure, without hindering the shaping, parallelism of the stage using the first detecting unit of a contact type that is low cost.

(2) In the three-dimensional shaping apparatus according to the aspect, the three-dimensional shaping apparatus may further include a plate-like heating unit located above the nozzle opening during the shaping of the three-dimensional shaped object and configured to heat the shaping material deposited on the deposition surface, the control unit may control the second moving unit to locate the first detecting unit below the heating unit when the parallelism is measured and locate the first detecting unit further on an outer side than a peripheral edge of the heating unit when the three-dimensional shaped object is shaped. According to such an aspect, it is possible to prevent the first detecting unit and the heating unit from coming into contact.

(3) In the three-dimensional shaping apparatus according to the aspect, the first moving unit may include a driving unit configured to change the relative positions of the nozzle and the stage in a first direction perpendicular to the deposition surface, the first detecting unit may include a contact unit configured to, in a state in which the first detecting unit is located below the heating unit, come into contact with a movable unit driven by the driving unit, and, when the parallelism is measured, the first detecting unit may be moved in the first direction by the first moving unit. According to such an aspect, it is possible to move the first detecting unit without separately providing a driving unit for moving the first detecting unit.

(4) In the three-dimensional shaping apparatus according to the aspect, the three-dimensional shaping apparatus may further include a plate-like heating unit located above the nozzle opening during the shaping of the three-dimensional shaped object and configured to heat the shaping material deposited on the deposition surface, the control unit may control the second moving unit to locate the first detecting unit below the heating unit when the parallelism is measured and locate the first detecting unit above the heating unit when the three-dimensional shaped object is shaped. According to such an aspect, it is possible to prevent the first detecting unit and the heating unit from coming into contact.

(5) In the three-dimensional shaping apparatus according to the aspect, a shape of the heating unit may be a rectangle when viewed from a first direction perpendicular to the deposition surface, the first moving unit may change relative positions of the heating unit and the stage in a range in which at least a part of the heating unit and at least a part of the stage overlap when viewed from the first direction, and a plurality of the first detecting units may be respectively provided in regions corresponding to at least two corners among four corners at a time when the heating unit is equally divided into lateral four regions and longitudinal four regions when viewed from the first direction, sixteen regions in total. According to such an aspect, positions of the deposition surface that cannot be measured by one first detecting unit can be measured by the other first detecting unit.

(6) In the three-dimensional shaping apparatus according to the aspect, the control unit may acquire unevenness information representing unevenness positions of the deposition surface and determine measurement positions of the deposition surface by the first detecting unit according to the unevenness information. According to such an aspect, it is possible to accurately measure the parallelism of the deposition surface.

(7) In the three-dimensional shaping apparatus according to the aspect, the three-dimensional shaping apparatus may further include a second detecting unit of a contact type configured to move in association with the stage, and the first detecting unit and the second detecting unit may be configured such that, when the first detecting unit and the second detecting unit come into contact, specific one detecting unit of the first detecting unit and the second detecting unit detects the contact. According to such an aspect, since a detection source of contact does not vary, it is possible accurately measure the distance between the first detecting unit and the second detecting unit.

(8) In the three-dimensional shaping apparatus according to the aspect, the control unit may measure a distance between the nozzle and the deposition surface by controlling the first moving unit and the second moving unit to execute first processing for bringing the first detecting unit and the second detecting unit into contact, second processing for bringing the first detecting unit and the deposition surface into contact, and third processing for bringing the second detecting unit and the nozzle into contact. According to such an aspect, it is possible to accurately measure the distance between the nozzle and the deposition surface.

(9) In the three-dimensional shaping apparatus according to the aspect, a plurality of the first detecting units configured to come into contact with different positions of the deposition surface may be fixed to a holder, and the second moving unit may move the holder. According to such an aspect, the parallelism of the deposition surface can be efficiently measured by the plurality of first detecting units.

The present disclosure is not limited to the aspects of the three-dimensional shaping apparatus explained above and can be implemented by various aspects such as a manufacturing method for a three-dimensional shaped object and a measurement method for parallelism.

What is claimed is:

1. A three-dimensional shaping apparatus comprising:
a shaping unit including a nozzle that ejects a shaping material from a nozzle opening formed at a distal end;
a stage having a deposition surface on which the shaping material is deposited;
a first detecting unit including a contactor and configured to come into contact with the deposition surface to thereby measure parallelism of the deposition surface;
a first moving unit configured to change relative positions of the nozzle and the stage;
a second moving unit configured to change a position of the first detecting unit; and
a control unit, wherein
the control unit controls the second moving unit to locate the first detecting unit on an inner side of a shaping region between the nozzle and the deposition surface when the parallelism is measured and locate the first detecting unit on an outside of the shaping region when a three-dimensional shaped object is shaped.

2. The three-dimensional shaping apparatus according to claim 1, further comprising a plate-like heating unit located above the nozzle opening during the shaping of the three-dimensional shaped object and configured to heat the shaping material deposited on the deposition surface, wherein
the control unit controls the second moving unit to locate the first detecting unit below the heating unit when the parallelism is measured and locate the first detecting unit further on an outer side than a peripheral edge of the heating unit when the three-dimensional shaped object is shaped.

3. The three-dimensional shaping apparatus according to claim 2, wherein
the first moving unit includes a driving unit configured to change the relative positions of the nozzle and the stage in a first direction perpendicular to the deposition surface,
the first detecting unit includes a contact unit configured to, in a state in which the first detecting unit is located below the heating unit, come into contact with a movable unit driven by the driving unit, and, when the parallelism is measured, the first detecting unit is moved in the first direction by the first moving unit.

4. The three-dimensional shaping apparatus according to claim 1, further comprising a plate-like heating unit located above the nozzle opening during the shaping of the three-dimensional shaped object and configured to heat the shaping material deposited on the deposition surface, wherein
the control unit controls the second moving unit to locate the first detecting unit below the heating unit when the parallelism is measured and locate the first detecting unit above the heating unit when the three-dimensional shaped object is shaped.

5. The three-dimensional shaping apparatus according to claim 4, wherein
a shape of the heating unit is a rectangle when viewed from a first direction perpendicular to the deposition surface,
the first moving unit changes relative positions of the heating unit and the stage in a range in which at least a part of the heating unit and at least a part of the stage overlap when viewed from the first direction, and
a plurality of the first detecting units are respectively provided in regions corresponding to at least two corners among four corners at a time when the heating unit is equally divided into lateral four regions and longitudinal four regions when viewed from the first direction, sixteen regions in total.

6. The three-dimensional shaping apparatus according to claim 1, wherein the control unit acquires unevenness information representing unevenness positions of the deposition surface and determines measurement positions of the deposition surface by the first detecting unit according to the unevenness information.

7. The three-dimensional shaping apparatus according to claim 1, further comprising a second detecting unit of a contact type configured to move in association with the stage, wherein
the first detecting unit and the second detecting unit are configured such that, when the first detecting unit and the second detecting unit come into contact, specific one detecting unit of the first detecting unit and the second detecting unit detects the contact.

8. The three-dimensional shaping apparatus according to claim 7, wherein
the control unit measures a distance between the nozzle and the deposition surface by executing first processing for bringing the first detecting unit and the second detecting unit into contact, second processing for bringing the first detecting unit and the deposition surface into contact, and third processing for bringing the second detecting unit and the nozzle into contact.

9. The three-dimensional shaping apparatus according to claim 1, wherein
a plurality of the first detecting units configured to come into contact with different positions of the deposition surface are fixed to a holder, and
the second moving unit moves the holder.
